(19) United States
(12) Patent Application Publication
(10) Pub. No.: US 2015/0100882 A1
(43) Pub. Date: Apr. 9, 2015

(54) METHOD AND SYSTEM FOR INTERACTIVE FONT FEATURE ACCESS

(71) Applicant: COREL CORPORATION, Ottawa (CA)

(72) Inventors: Tony Severenuk, Kemptville (CA); Claude Peloquin, Gatineau (CA); Pauline Branigan, Ottawa (CA); Neville Wai Chun Ko, Nepean (CA)

(21) Appl. No.: 14/386,573

(22) PCT Filed: Mar. 19, 2013
(86) PCT No.: PCT/CA2013/000360

§ 371 Date: Sep. 19, 2014

(30) Foreign Application Priority Data
Mar. 19, 2012 (CA) 2,772,554

(51) Int. Cl. G06F 17/21; G06F 3/0482; G06F 3/0484

(52) U.S. Cl. CPC G06F 17/214; G06F 3/04842; G06F 3/0482
USPC 715/269

(57) ABSTRACT

OpenType fonts have become a standard with desktop published with over 150,000 fonts available each potentially comprising up to 65,535 characters and even more glyphs. Accordingly it is difficult for anybody to know the endless combinations for every font or even a significant subset of these OpenType fonts. At present users must go through a series of trial and error modifications to observe the fonts inherent design variations to find either the one they want or determine that the font is not appropriate. Embodiments of the invention in contrast provide users with a solution wherein the appearance of the characters and/or glyphs is first determined by the system and then presented to the user. Based on the appearance of the characters the user can then select the appearance they desire and the system determines which features are required for that appearance and proceeds accordingly.

### FIELD OF THE INVENTION

The present invention relates to fonts and more specifically to displaying font options to a user without knowledge of the font's structure.

### BACKGROUND OF THE INVENTION

A font was traditionally defined as a quantity of sorts composing a complete character set of a single size and style of a particular typeface. For example, the complete set of all the characters for “9-point Bulmer” was called a font, and “10-point Bulmer” another separate font, but part of the same font family, whereas “9-point Bulmer boldface” would be another font in a different font family of the same typeface. However, today font is frequently used synonymously with the term typeface, although they had clearly understood different meanings before the advent of digital typography and desktop publishing.

Beginning in the 1980s, with the introduction of computer fonts, a broader definition for the term “font” evolved, because different sizes of a single style which had been separate fonts in metal type were now generated from a single computer font, because vector shapes can be scaled freely. As such there is no separate font for “9-point Bulmer italic” as opposed to “10-point Bulmer italic”. “Bulmer”, the typeface, may include the fonts “Bulmer roman”, “Bulmer italic”, “Bulmer bold” and “Bulmer extended”. Accordingly, a wide variety of applications including, but not limited to, word processors, graphics design suites, graphics presentation suites, web publishing applications and operating systems are bought with a library of standard fonts and the applications allow the user to access fonts as well as some characteristics of those fonts. By the late 1980s Apple had developed “TrueType” as an outline font standard to compete with Adobe's Type 1 fonts used in PostScript offering font developers a high degree of control over precisely how their fonts are displayed

Microsoft failure to license Apple's advanced typography technology in the early 1990s led to their own solution, dubbed “TrueType Open”, released in 1994. Adobe joined Microsoft in 1996, adding support for the glyph outline technology used in its Type 1 fonts. A glyph being an individual element of writing where the individual mark contributes to the meaning of what is written. At the same time the two companies recognised the need for an expressive font format capable of handling fine typography and the complex behavior of many of the world's writing systems and expanded “TrueType Open” adding new extensions to address these limitations, naming the combined technology “OpenType” and continuing to develop the OpenType approach as a proprietary solution until 2005. At this point OpenType began migrating to an open standard under the International Organization for Standardization (ISO) within the MPEG group, which had previously adopted OpenType 1.4 by reference for MPEG-4. Adoption of the new standard reached formal approval in March 2007 as ISO Standard ISO/IEC 14496-22 (MPEG-4 Part 22) called Open Font Format (OFF) but is also referred to as the “Open Font Format Specification” (OFFS).

Commercial OpenType fonts were on the market a decade ago in hundreds of fonts. By 2005 that had grown to around 10,000 and today FontShop (www.fontshop.com) alone carries over 150,000 fonts for commercial and private use for in applications from publishing to website design to digital marketing to product and company branding. With the PostScript format established by Adobe in the 1980s being limited to 256 characters per file metrics information and extra characters often needing to be stored in additional files becoming especially unwieldy, e.g. with a Windows TrueTypefont where a single typeface family could require hundreds of pieces. OpenType removed those organizational issues and provided, based on Unicode, a file format that could contain up to 65,535 characters or glyphs once the number of glyphs is included, this is pretty much limitless. The 65,535 count being implemented for Unicode, where there was one specific appearance for each character, or symbol for Asian/Middle East text. This allowed for extensive language support and made room for advanced typographic features like ligatures, various figure styles, fractions, stylistic alternates, swashes, small caps, ornaments, borders, and so on. Accordingly, a single OpenType file contains all the information required for a typeface style: metrics, kerning, outlines, and hinting, plus potentially other contents including bitmaps.

However, designers are now faced with a different challenge in that knowing which of these advanced typographic features including, but not limited to, ligatures, multiple figure styles, fractions, stylistic alternates, swashes, small caps, ornaments, borders, etc. the font developer has included within the font. Whilst this may be relatively complex mental task for a designer who only works with a couple of common fonts, e.g. Arial and Times New Roman, it is an incredibly difficult if not impossible task for a designer with a couple of hundred fonts yet alone a designer seeking new fonts from online stores such as FontShop with over 150,000 fonts and more being added daily. For the average individual even common fonts present an incredibly complex array of options for each one.

Accordingly as nobody could know the endless combinations for every font, they have to go through a series of trial and error modifications by clicking on buttons or selecting items in a dropdown list and then observing the effects upon the text they are working with. If they do not find that selected appearance attractive they have to undo these changes and then try another combination. It would therefore be beneficial to provide a user with a solution wherein the appearance of the characters and/or glyphs is first determined by the system and then presented to the user. Based on the appearance of the characters the user can then select the appearance they desire and the system determines which features are required for that appearance and proceeds accordingly.

Further, given a potential 65,535 characters and adding even more glyphs within a font it is very difficult for a designer to evaluate a potential font as one that they wish to purchase in any significant extent even where an online font retailer provides a list of the glyphs. It would therefore be beneficial for a user to evaluate a font within their own publishing, desktop or mobile environment that they are working within prior to having to commit to purchasing it.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address drawbacks within the prior art relating to Fonts and more specifically to displaying font options to a user without knowledge of the font's structure.

In accordance with an embodiment of the invention there is provided a method comprising:
a) receiving with a microprocessor an indication relating to a selection of at least one character of a plurality of characters displayed to a user, the at least one character displayed according to a predetermined font;
b) automatically determining with the microprocessor whether at least one option of a plurality of options exists, each option relating to the predetermined font and determined in dependence upon at least the available variations for displaying the predetermined font; and
c) presenting to the user the at least one character using the at least one option of the plurality of options where the determination is made that the at least one option exists.

In accordance with an embodiment of the invention there is provided a method comprising:
a) displaying to a user at least one menu of a plurality of menus, each menu relating to an aspect of a font and comprising at least an option of a plurality of options;
b) receiving with a microprocessor an indication relating to a selection of the least one option of the plurality of options within the one menu of the plurality of menus; and
c) automatically determining with the microprocessor a plurality of fonts, each font of the plurality of fonts having a characteristic fulfilling the selection of the least one option of the plurality of options within the one menu of the plurality of menus.

In accordance with an embodiment of the invention there is provided a method comprising:
a) providing a software application in execution upon a computer system comprising at least a microprocessor, the computer system connected to a network;
b) receiving a selection from a user of the software application relating to a font not currently installed for use within the software application; and
c) retrieving from a server coupled to the computer network a font file relating to the font; and
d) installing temporarily the font for use by a user of the software application.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a font selection process within a software application according to the prior art;

FIG. 2 depicts font modification process within a software application according to the prior art;

FIG. 3 depicts an OpenType font modification process within a software application according to the prior art;

FIG. 4A depicts a flow chart for an OpenType font modification process within a software application according to an embodiment of the invention;

FIG. 4B depicts a flow chart for an OpenType font modification process within a software application according to an embodiment of the invention;

FIG. 5 depicts an OpenType font modification process within a software application according to an embodiment of the invention;

FIG. 6 depicts an OpenType font modification process within a software application according to an embodiment of the invention;

FIG. 7 depicts an OpenType font selection process within a software application according to an embodiment of the invention;

FIG. 8 depicts an OpenType font evaluation process within a software application according to an embodiment of the invention;

FIG. 9 depicts a network supporting communications between devices and remote servers according to embodiments of the invention; and

FIG. 10 depicts a device and associated access point supporting communications to remote servers according to embodiments of the invention.

### DETAILED DESCRIPTION

The present invention is directed to Fonts and more specifically to displaying font options to a user without knowledge of the font's structure.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a device used for communication by wireless and/or wired interfaces that requires connection to a mains electrical network as its source of electrical power or other dependent form of energy for power. This includes devices, but is not limited to, such as desktop computers, computer aided design stations, kiosks, and televisions supporting software applications.

A “computer system” as used herein and throughout this disclosure, refers to a PED or FED that supports execution of one or more software applications including, but not limited to, those relating to word processing, graphics generation, desktop publishing, web page design, and website creation.

A “network operator/service provider” as used herein may refer to, but is not limited to, a telephone or other company that provides services for subscribers including voice, text, and Internet; a telephone or other company that provides services for subscribers including but not limited to voice, text, Voice-over-IP, and Internet; a telephone, cable or other company that provides wireless and/or access to local area, metropolitan area, and long-haul networks for data, text, Internet, and other traffic or communication sessions; etc.

A “user,” as used herein and through this disclosure refers to, but is not limited to, a person that utilizes a FED, PED, or computer system to access and use a software application thereby employing one or more OpenType fonts.

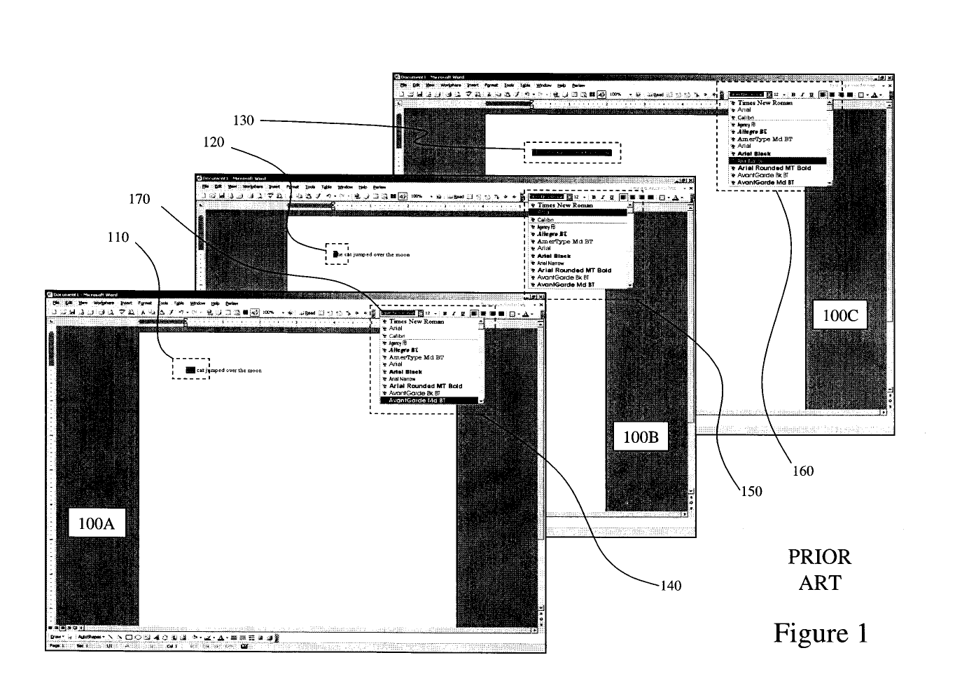

Referring to FIG. 1 there are depicted first to third screenshots 100A through 100C respectively during font selection processes within a software application according to the prior art. Each of the first to third screenshots 100A through 100C respectively relating to a scenario wherein the user has selected a single word, single character, and portion of text respectively. In each instance the user accesses a tool bar element 170 which accesses first to third drop-down menus 140 through 160 respectively providing the user with a list of fonts available to modify the text's font. In each instance of first to third drop-down menus 140 through 160 respectively the list of fonts is identical.

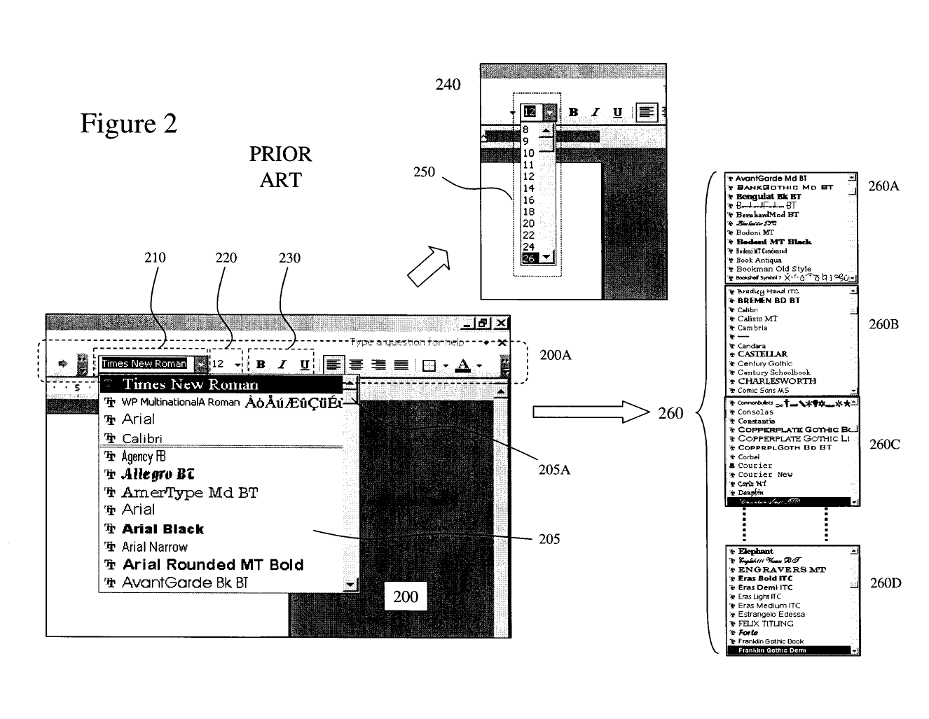

Now referring to FIG. 2 there is depicted a font modification process within a software application according to the prior art. Partial screenshot 200 depicts the drop-down menu 205 triggered from a tool bar element 210 that identifies the current font as “Times New Roman” and lists some of the font options accessible to the user. Also shown within the toolbar 200A are font size adjuster 220 and font amend icons 230. Font size adjuster 220 provides the user with a drop-down toolbar 250 as shown in second partial screenshot 240. The font amendment icons 230 being bold, italic, and underline. Within drop-down menu 205 a scroll-bar icon 205A provides the user with access to additional fonts as evident from extended menu 260 comprising first and fourth sub-menus 260A to 260D respectively.

A PostScript font is typically limited to 256 characters per file, although character identifier (CID) fonts specifically designed for the East Asian fonts can contain more than 256 glyphs. As such that metrics information, extra characters are typically stored in additional files such that the PostScript font may for example comprise Regular font file, Greek font file, Cyrillic font file, small caps file, Oldstyle figures file, Central European file, Ornaments, and Regular font for Windows file, Swashes file, as well as .afm (Adobe Fonts Metric) files, and .pfm (Printer Font Metrics) file. Separate files would be required for MAC™ and Windows™ operating environments. In comparison an OpenType file (OTF) supports both MAC™ and Windows™ environments as well as Regular, Small Caps, Ornaments and Borders, Languages (for example Baltic, Central European, Turkish, Greek and Cyrillic), Ligatures—Alternate Glyphs—Swashes, and Figures (for example Oldstyle, Lining, Proportional, Tabular, Fractions, Ordinals, Superscript and Subscript). Such an OTF can contain up to 65,535 characters together with all information relating to font metrics, kerning, outlines, and hints and potentially bitmaps.

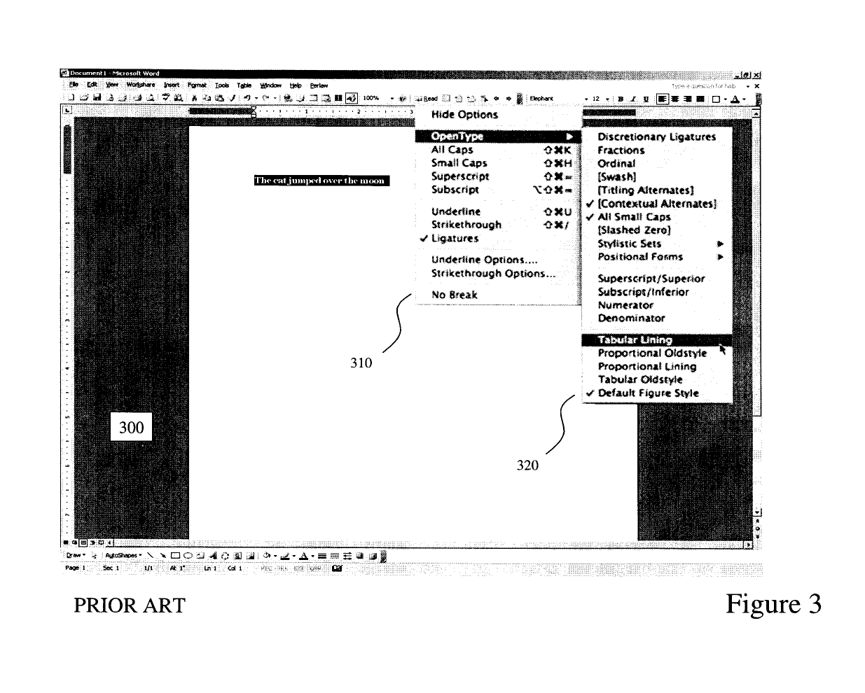

By way of example the multilingual PostScript version of the font “FF Meta 1” relating to four type styles comprises 360 files totaling 23.6 MB of data is reduced to 4 files totaling 676 kB when implemented in OpenType. Accordingly, in FIG. 3 there is depicted an OpenType font modification process within a software application according to the prior art within screen shot 300. Selection of a font type element within the tool bar triggers first option drop-down 310 relating to the font. As depicted the user has selected OpenType within first option drop-down 310 thereby triggering second option drop-down 320 which provides further options. Some elements within the second option drop-down 320 such as Stylistic Sets and Positional Forms, as indicated by the arrows, when selected trigger another option drop-down. It is evident therefore; that even within such a prior art approach the selection of a font characteristic employs multiple menus. If the selected characteristics are not the ones the user requires then they must either reverse the change through an “undo” command or repeat the process through the drop-down menus to select another characteristic.

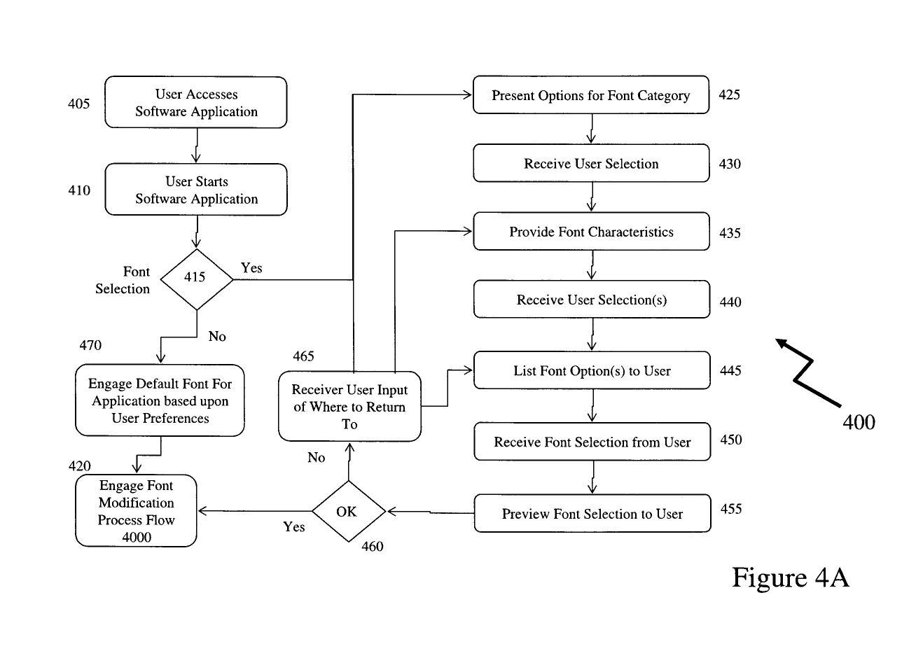

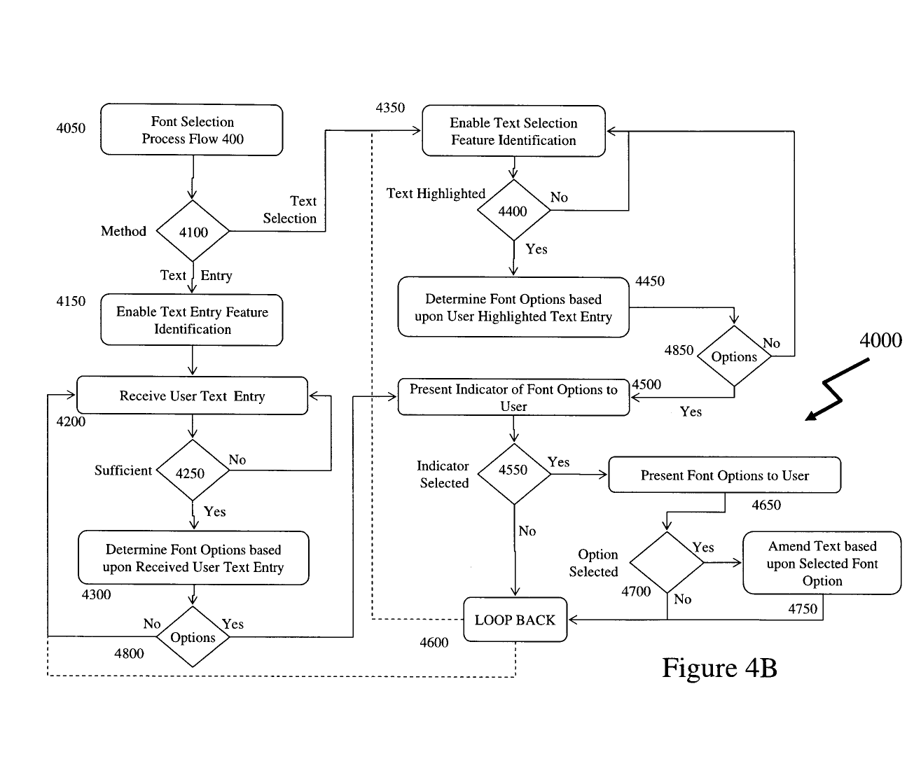

Referring to FIG. 4A there is depicted a process flow 400 according to an embodiment of the invention wherein in step 405 a user initially accesses a software application supporting use of OpenType fonts and proceeds to start the application in step 410. In step 415 the user is prompted as to whether they wish to select a font to work with wherein if an affirmative response is received the process proceeds to step 425 otherwise the process proceeds to step 470 wherein the software application enables the selected font based upon previously established user preferences, or defaults within the software application before proceeding to step 420 wherein a subsequent process flow 4000 as described below in respect of FIG. 4B is engaged.

In process step 425 the user is presented with options relating to a font category by the software application, such as a drop-down list, where such categories may include for example Sans, Serif, Slab, Script, Display, and Glyphs. In step 430 the process receives the user's selection of a font category, for example Glyphs, wherein they are presented with font characteristics which may include for example European alphabetic scripts, multiple language support, syllabic scripts, logographic scripts, weight or stroke width, style, character width, handwritten or cursive, ligatures, swashes and glyphs. Accordingly the user selects one or more characteristics they desire wherein the process proceeds to step 445 and are presented with a list of fonts that satisfy their one or more characteristics wherein the user may then select a desired font in step 450 wherein the process proceeds to step 455 and previews the font selected to the user in accordance with an embodiment of the invention or in a manner known within the prior art.

The process then proceeds to step 460 wherein the user is prompted as to whether they wish to accept their selection of not, wherein an affirmative response causes the process flow to proceed to step 420 wherein a subsequent process flow 4000 as described below in respect of FIG. 4B is engaged. A negative response results in the user being prompted in step 465 with options as to where they wish to return in the font selection process, namely font category, font characteristics, or font selection, wherein the process proceeds back to process steps 425, 435, and 445 respectively.

Optionally, rather than being prompted for font characteristics in step 435 the user may alternatively have been presented with a list of fonts or additional menu selections to refine the list of fonts. This may be necessary as many software applications, and operating systems, contain tens to hundreds of fonts, particularly those intended for graphics design applications and the initial font library may be expanded through purchasing third party libraries as well as discrete fonts. Alternatively they may simply type the font name into a dialog box as it is one they know even if they are not familiar with all of its characteristics and options.

Now referring to FIG. 4B there is depicted a process flow 4000 relating to a software application providing functionality according to embodiments of the invention. In step 4050 the process begins with the completion of the previously presented process flow 400 as described above in respect of FIG. 4A. Accordingly the process proceeds to step 4100 wherein the user is prompted as to whether they wish to be provided font characteristic options upon text entry or text selection. The former will provide options during their entry of text whereas the latter will provide the options once they have selected a portion of the text already entered. If the user selection is text selection then the process proceeds to step 4350 otherwise it proceeds to step 4150 and text entry feature identification is enabled.

Once text entry feature identification is enabled the process proceeds to step 4200 wherein the user begins to enter text and in step 4250 the process determines whether sufficient text has been entered wherein the process either proceeds to step 4300 or loops back to step 4250. The determination of sufficient text is, for example, context based so that for example a single letter wherein that letter is the beginning of a new paragraph or sentence is sufficient whereas within a sentence a predetermined number of characters or words may be required. In step 4300 the software application determines whether there are applicable font options based upon the received text entry or entries and proceeds to step 4800 wherein if font options exit the process proceeds to step 4500 otherwise it loops back to step 4200 and monitors again for further user text input. Process flow from step 4500 is discussed below after consideration of the process flow where the user has elected for text selection based determination in step 4100.

In step 4350 the software application enables text selection feature identification and proceeds to step 4400 where a determination is made as to whether the user has selected any text within the current document they are working upon. A negative determination causes the process to loop back to step 4350 whereas a positive determination causes the process to proceed to step 4450 wherein a determination of whether font options based upon the highlighted (selected) text are available and in step 4850 either loops back to step 4350 if none exist or proceeds to step 4500 where options exist. Step 4500 presents an indicator to the user that font options exist according to either their text entry or their text selection and the process proceeds to step 4450 wherein a determination is made as to whether the user selects the indicator by for example clicking on it, making a swiping motion on a touch screen close to the indicator, or pulling it down with a mouse. The user may elect to ignore the indicator wherein the process proceeds to step 4600 and thereafter loops back to either step 4200 or 4350 based upon the user's previous selection in step 4100 of the method of being prompted regarding options.

If the user elects to evoke the indicator in step 4550 the process proceeds to step 4650 wherein the determined font options are presented to the user. The presented font options may, for example, be all available options for the current active font where the user has elected text entry, all common options relating to the one or more fonts within the selected text, or a subset of the available options. Where a subset of the options available are presented these may be determined in dependence upon one or more factors including, but not limited to, the preferences of the user through their preceding selections within this document, the preferences of the user through preceding selections generally, the context of the text being modified, the position of the text within the content of the document, the language of the text, the nature of the document within which the content occurs, software application defaults, and the text itself.

From step 4550 the process proceeds to step 4650 wherein it is determined whether the user has selected one of the available font options or not. Such a selection may for example be placing a cursor over the font option and clicking in a mouse or pointer driven environment or tapping the font option in a touch screen based environment. If not the process proceeds to step 4600 and loops back as discussed supra otherwise the process proceeds to step 4750 and applies the font option selected to the text before proceeding to step 4600. It would be evident to one skilled in the art that optionally additional steps may be included or some steps excluded within the process flows described above without departing from the scope of the invention. For example, once the selected font option has been applied in step 4750 in process flow 4700 of FIG. 4B the user may be required to select a confirm option or an undo option. In the former instance subsequent actions by the user would automatically undo the modification wherein the latter the continuation of subsequent actions would be a confirmation of acceptance of the modifications.

Optionally, within embodiments of the invention the software application may additionally determine during text entry whether particular words have been entered by cross reference to one or more libraries, for example an installed library of the software application or a user specific library. In such instances the font options presented to the user may be determined in dependence of the occurrence of the word within a library or the word itself. Alternatively some instances may automatically trigger the insertion of an additional element, for example a glyph, within the text. Optionally in step 4600 the process may loop back to step 4200 for the user to adjust the identification method for options or alternatively the user may make this adjustment at other points by using a toolbar icon or feature as would be known to one skilled in the art. It would also be evident that in other embodiments of the invention the user may hover a cursor over an element of the text whereby after a predetermined period of time the software application triggers the display of font options to the user.

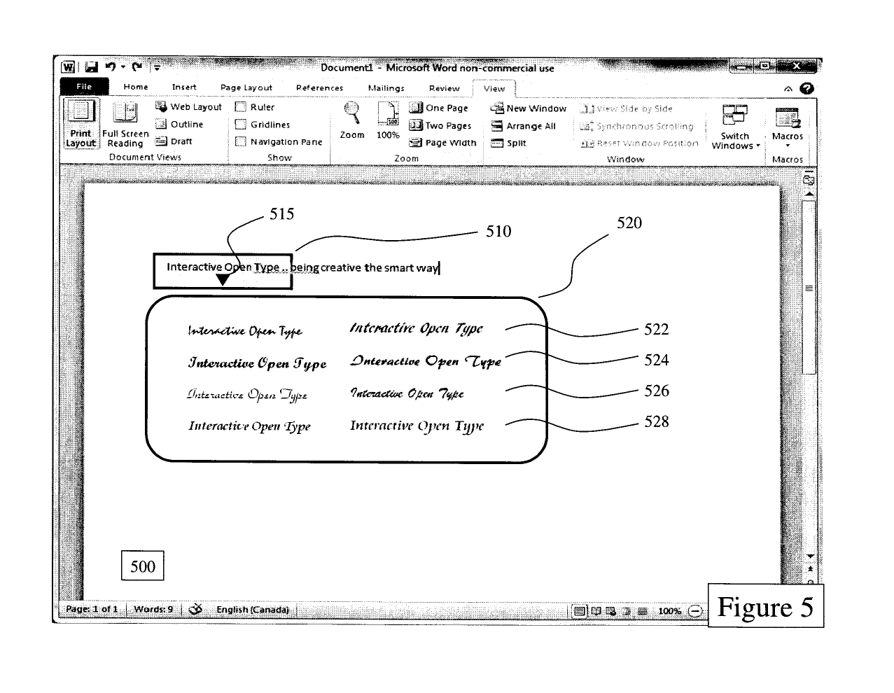

Referring to FIG. 5 there is depicted an OpenType font modification process within a software application according to an embodiment of the invention wherein within a screenshot 500 the user has selected a text string “Interactive Open Type” which is indicated by highlight 510. In their doing so an indicator 515 is displayed to the user indicating that there are options relating to the font which may be displayed. If the user selects this indicator 515 then these are displayed in pop-up 520 displaying the different font options to the user including first to fourth font options 522 through 528 respectively. The options displayed within the pop-up 520 may be determined in dependence upon a combination of factors including for example, but not limited to, the current characteristic of the font selected, selected character or characters, the current font, user preferences, previous user actions, and the text selected by the user. For example, the options may be different if a single letter is selected, multiple letters are selected, numeric content is selected versus text or whether the text includes the first word of a sentence or not.

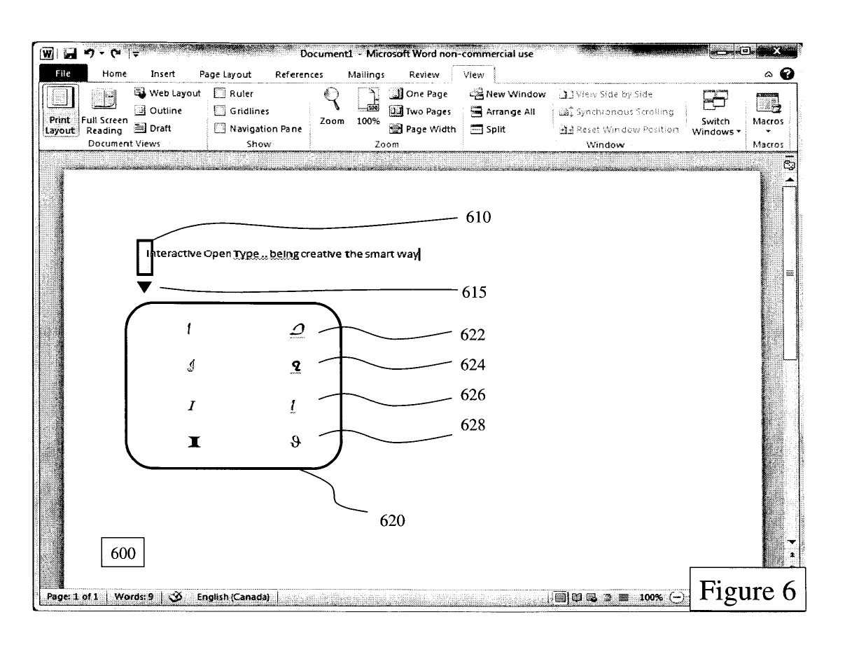

Referring to FIG. 6 there is depicted an OpenType font modification process within a software application according to an embodiment of the invention wherein within a screenshot 600 the user has selected the capital letter “I” which is indicated by highlight 610. In their doing so an indicator 615 is displayed to the user indicating that there are options relating to the font which may be displayed. If the user selects this indicator 615 by an action then these are displayed in pop-up 620 displaying the different font options to the user including first to fourth font options 622 through 628 respectively. The options displayed within the pop-up 620 may be determined in dependence upon a combination of factors including for example, but not limited to, the current characteristic of the font selected, the current font, user preferences, previous user actions, and the text selected by the user. In this example, the user has selected only the first capital letter rather than the text string described above in respect of FIG. 5, and accordingly the options presented are different to those above in respect of FIG. 5. Likewise the options presented may be different if numeric content is selected versus text or whether the text includes a glyph, multiple paragraphs, etc.

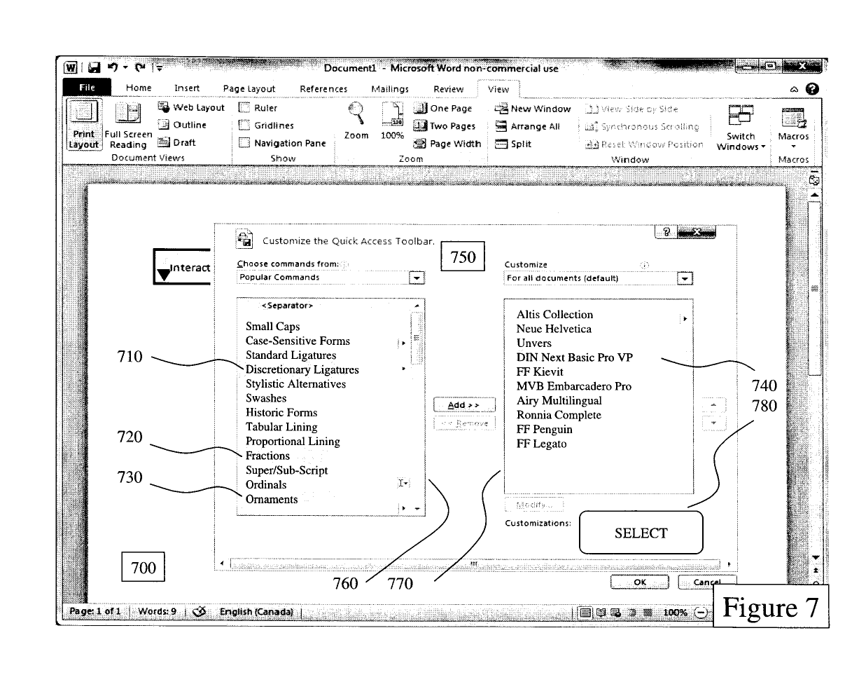

Now referring to FIG. 7 there is depicted an OpenType font selection process within a software application according to an embodiment of the invention. As depicted a screenshot 700 of a software application wherein where a user has selected an option triggering a window 750 which relates to selecting a font based upon the characteristics that the user wishes to employ. Accordingly, within window 750 there is provided a feature list 760, within which the user has selected Discretionary Ligatures 710, Fractions 720, and Ornaments 730, and result list 770 which lists Altos Collection, Neue Helveticam Unvers, DIN Next Basic Pro 740, FF Kievit, MVB Embarcadero, Airy Multilingual, Ronnia Complete, FF Penguin, and FF Legato. The user having selected DIN Next Basic Pro 740 would then select with button 780 thereby engaging that font. Optionally, user selection of one or more of the fonts listed in result list 770 prior to user confirmation with button 780 triggers modification of the user selected text to provide a preview to the user of the font selected prior to their confirmation. Subsequently the user would then be provided options relating to the selected font in a manner similar to that described above in respect of FIGS. 5 and 6.

Within the embodiments of the invention described above in respect of FIGS. 5 through 7 the user selects and works with fonts currently installed within the software application and/or software system. These fonts having been provided with the software application at installation or having been subsequently purchased by the user. However, as evident from the discussions above in respect of FIG. 3 and the extensive character set and characteristics of an OpenType font and the requirements to present font options to the user it is difficult for the user to fully appreciate all the characteristics of the font or it's suitability prior to their purchasing the font. Accordingly it would be beneficial for the user to be provided with an option to borrow a font within the application they are going to employ it so that they can see how the font looks upon their desired text.

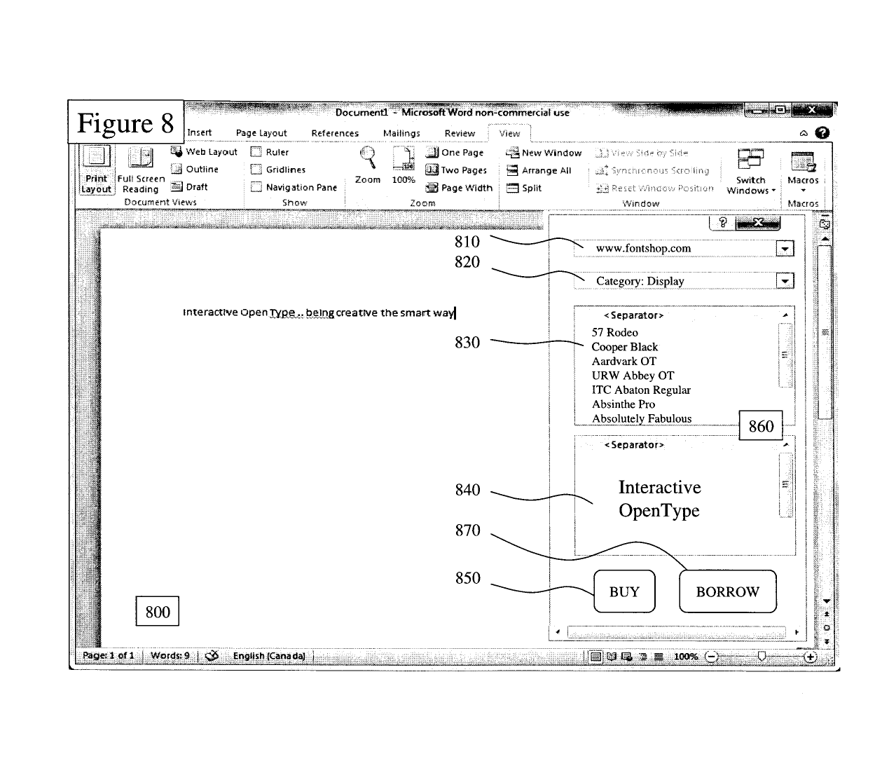

Referring to FIG. 8 there is depicted an OpenType font evaluation window 860 within a software application 800 according to an embodiment of the invention. As depicted font evaluation window 860 allows the user to select a website in website selector 810, a category of fonts in category selector 820, and a font 830 from those returned within their category of choice. A selected font 830 results in a display 840 of an element of text which may for example be that currently selected within the software application or a default alphanumeric string. The user is presented with buttons for Buy 850 and Borrow 870. The Borrow 870 button temporarily downloads the font 830 into the software application 800 allowing it to be used by the user within the software application 800 and the different characteristics demonstrated and reviewed using the features of the software application 800 which is operating according to embodiments of the invention and provides user guide features such as described above in respect of FIGS. 5 through 6 for example.

If the user likes the font then they may then select to purchase the font 830 via the Buy 850 button. Upon purchase completion the font 830 is installed, which may be for example solely for use by the software application alone or by all software applications. Optionally, this font installation process is performed within the software application itself, by triggering a font installation application upon the user's software system, or by launching a web based installation process.

It would be evident to one skilled in the art that the OpenType font evaluation window 860 within the software application 800 causes the software application 800 to access a remote computer server via a network to which the computer system executing the software application 800 and computer server are connected, for example the Internet. The computer server may be one associated, for example, with the provider of the software application, the provider of another software application, and a third party provider of fonts. Whilst the description above in respect of FIG. 8 discusses the user's evaluation within an OpenType font evaluation window it would be evident to one skilled in the art that alternatively the evaluation may be performed within the software application. The font being borrowed may, for example, be stored only within a volatile memory of the computer system during the evaluation or may as would be evident to one skilled in the art that the font may be provided in an encrypted file for which the decryption key has limited validity and that if purchased the software application receives a decryption key to decrypt and re-store the font in unencrypted form. Other approaches to protect the borrowed font would be evident to one skilled in the art. Optionally, the font borrowed may be free but the user employs the OpenType font evaluation window to select an appropriate font to meet their requirements.

It would be evident to one skilled in the art that the embodiments of the invention presented supra in respect of FIGS. 4A through 8 whilst being presented and described with respect to OpenType fonts, which present benefits of reduced file complexity and memory requirements, may be applied to other font formats including, but not limited to, TrueType, PostScript, and Embedded OpenType. Accordingly, in using such font formats the determination of options available to a user may require that multiple files are either searched or identified as present.

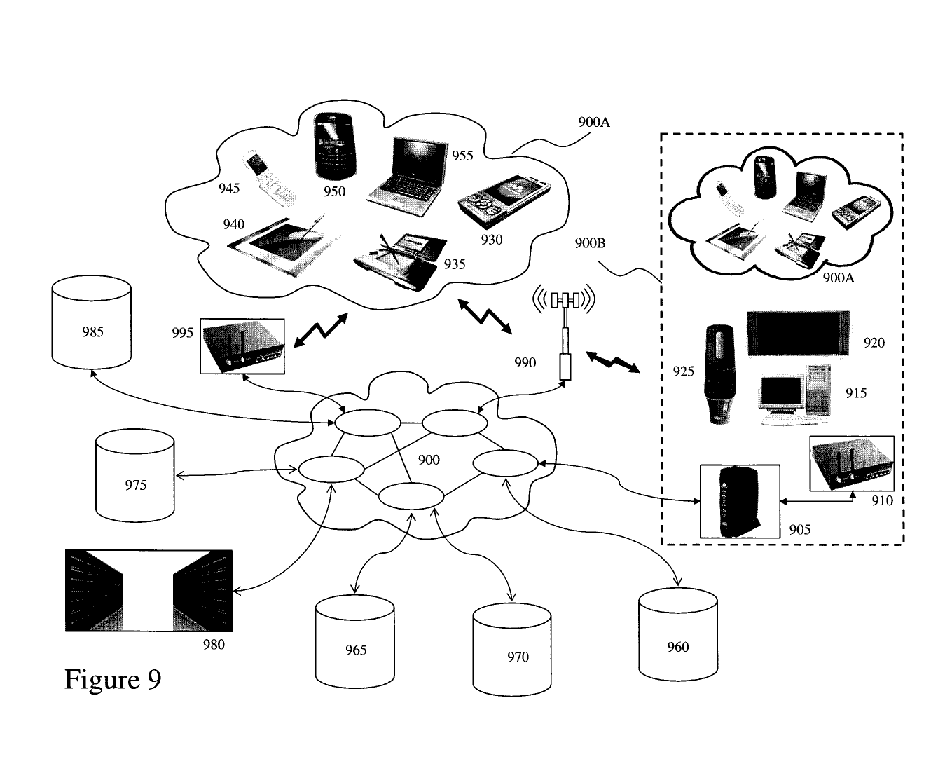

Referring to FIG. 9 there is depicted a network supporting communications and interactions between devices connected to the network according to embodiments of the invention with geographically separate first and second user groups 900A and 900B respectively interfacing to a telecommunications network 900. Within the representative telecommunication architecture a remote central exchange 980 communicates with the remainder of a telecommunication service providers network via the network 900 which may include for example long-haul OC-48/OC-192 backbone elements, an OC-48 wide area network (WAN), a Passive Optical Network, and a Wireless Link. The central exchange 980 is connected via the network 900 to local, regional, and international exchanges (not shown for clarity) and therein through network 900 to first and second wireless access points (AP) 995 and 910 respectively which provide Wi-Fi cells for first and second user groups 900A and 900B respectively.

Within the cell associated with first AP 995 the first group of users 900A may employ a variety of portable electronic devices including for example, laptop computer 955, portable gaming console 935, tablet computer 940, smartphone 950, cellular telephone 945 as well as portable multimedia player 930. Within the cell associated with second AP 910 the second group of users 900B may employ a variety of portable electronic devices such as those identified with first group of users 900A identified above including for example, laptop computer 955, portable gaming console 935, tablet computer 940, smartphone 950, cellular telephone 945 as well as portable multimedia player 930. Additionally within the second group of users 900B may employ a variety of fixed electronic devices including for example gaming console 925, personal computer 915 and wireless/Internet enabled television 920 as well as cable modem 905.

Also connected to the network 900 is cell tower 990 that provides, for example, cellular GSM (Global System for Mobile Communications) telephony services as well as 3G and 4G evolved services with enhanced data transport support. Cell tower 990 proves coverage in the exemplary embodiment to first and second user groups 900A and 900B. Alternatively the first and second user groups 900A and 900B may be geographically disparate and access the network 900 through multiple cell towers, not shown for clarity, distributed geographically by the network operator or operators. Accordingly, the first and second user groups 900A and 900B may according to their particular communications interfaces communicate to the network 900 through one or more communications standards such as, for example, IEEE 802.3, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOW and Internet access.

Also communicated to the network 900 are first and second servers 975 and 985 respectively which host according to embodiment of the inventions multiple services associated with a provider of the software system(s) and software application(s) associated with the OpenType fonts including, but not limited to, font libraries, font databases, OpenType resources, user guides, font developer contact information, FED specific fonts, and PED specific fonts. First and second servers 975 and 985 respectively may also host for example other Internet services such as a search engine, financial services relating to font providers, financial services relating to third party font retailers, user accounts, font metric guides, and other Internet based services. Also coupled to network 900 are first to third software providers 960, 965 and 970 respectively who may provide fonts directly to users as updates and/or upgrades to their software as well as discrete fonts and software applications.

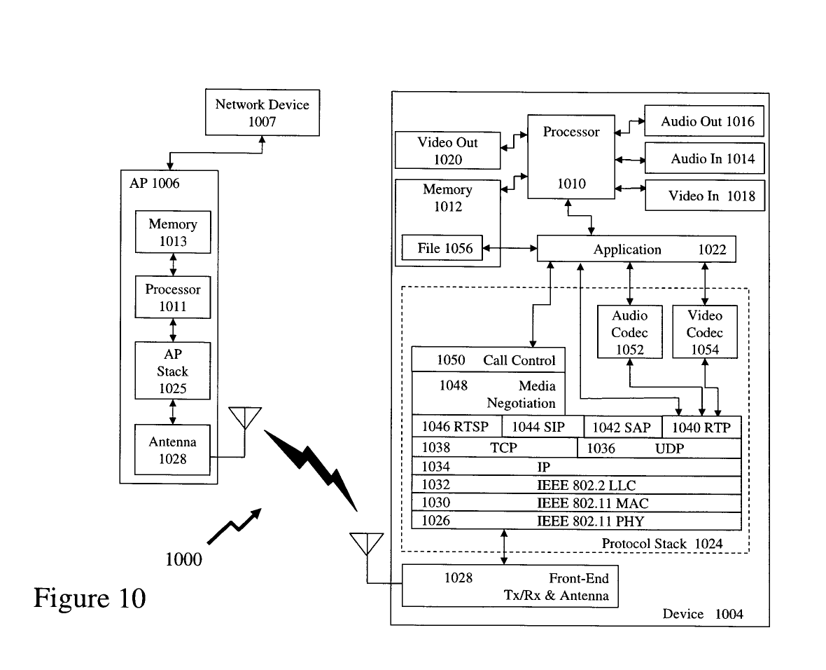

Referring to FIG. 10 there is depicted a portable electronic device (PED) 1004, supporting communications and interactions according to embodiments of the invention. Also depicted within the PED 1004 is the protocol architecture as part of a simplified functional diagram of a system 1000 that includes a portable electronic device (PED) 1004, such as a smartphone 955, an access point (AP) 1006, such as first Wi-Fi AP 910, and one or more network devices 1007, such as communication servers, streaming media servers, and routers for example such as first and second servers 975 and 985 respectively. Network devices 1007 may be coupled to AP 1006 via any combination of networks, wired, wireless and/or optical communication links such as discussed above in respect of FIG. 9. The PED 1004 includes one or more processors 1010 and a memory 1012 coupled to processor(s) 1010. AP 1006 also includes one or more processors 1011 and a memory 1013 coupled to processor(s) 1011. A non-exhaustive list of examples for any of processors 1010 and 1011 includes a central processing unit (CPU), a digital signal processor (DSP), a reduced instruction set computer (RISC), a complex instruction set computer (CISC) and the like. Furthermore, any of processors 1010 and 1011 may be part of application specific integrated circuits (ASICs) or may be a part of application specific standard products (ASSPs). A non-exhaustive list of examples for memories 1012 and 1013 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

PED 1004 may include an audio input element 1014, for example a microphone, and an audio output element 1016, for example, a speaker, coupled to any of processors 1010. PED 1004 may include a video input element 1018, for example, a video camera, and a video output element 1020, for example an LCD display, coupled to any of processors 1010. PED 1004 includes one or more applications 1022 that are typically stored in memory 1012 and are executable by any combination of processors 1010. PED 1004 includes a protocol stack 1024 and AP 1006 includes a communication stack 1025. Within system 1000 protocol stack 1024 is shown as IEEE 802.11 protocol stack but alternatively may exploit other protocol stacks such as an Internet Engineering Task Force (IETF) multimedia protocol stack for example. Likewise AP stack 1025 exploits a protocol stack but is not expanded for clarity. Elements of protocol stack 1024 and AP stack 1025 may be implemented in any combination of software, firmware and/or hardware. Protocol stack 1024 includes an IEEE 802.11-compatible PHY module 1026 that is coupled to one or more Front-End Tx/Rx & Antenna 1028, an IEEE 802.11-compatible MAC module 1030 coupled to an IEEE 802.2-compatible LLC module 1032. Protocol stack 1024 includes a network layer IP module 1034, a transport layer User Datagram Protocol (UDP) module 1036 and a transport layer Transmission Control Protocol (TCP) module 1038.

Protocol stack 1024 also includes a session layer Real Time Transport Protocol (RTP) module 1040, a Session Announcement Protocol (SAP) module 1042, a Session Initiation Protocol (SIP) module 1044 and a Real Time Streaming Protocol (RTSP) module 1046. Protocol stack 1024 includes a presentation layer media negotiation module 1048, a call control module 1050, one or more audio codecs 1052 and one or more video codecs 1054. Applications 1022 may be able to create maintain and/or terminate communication sessions with any of devices 1007 by way of AP 1006. Typically, applications 1022 may activate any of the SAP, SIP, RTSP, media negotiation and call control modules for that purpose. Typically, information may propagate from the SAP, SIP, RTSP, media negotiation and call control modules to PHY module 1026 through TCP module 1038, IP module 1034, LLC module 1032 and MAC module 1030.

It would be apparent to one skilled in the art that elements of the PED 1004 may also be implemented within the AP 1006 including but not limited to one or more elements of the protocol stack 1024, including for example an IEEE 802.11-compatible PHY module, an IEEE 802.11-compatible MAC module, and an IEEE 802.2-compatible LLC module 1032. The AP 1006 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module.

A fixed electronic device or FED may be similarly structured to a PED 1004, for example where the FED is a gaming console or desktop computer with wireless interface. Optionally a FED may also support another interface such as IEEE 802.3 Ethernet discretely or in combination with IEEE 802.11 or be interfaced to network 900 via a cable or satellite set-top box. Accordingly, a borrower may utilise a PED or FED to access the network 900 and utilise one or more software applications and accordingly use of one or more OpenType fonts such as described above in respect of FIGS. 5 to 8.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
a) receiving with a microprocessor an indication relating to a selection of at least one character of a plurality of characters displayed to a user, the at least one character displayed according to a predetermined font;
b) automatically determining with the microprocessor whether at least one option of a plurality of options exists, each option relating to the predetermined font and determined in dependence upon at least the available variations for displaying the predetermined font; and
c) presenting to the user the at least one character using the at least one option of the plurality of options where the determination is made that the at least one option exists.

2. The method according to claim 1 wherein,
each option is also determined in dependence upon the at least one character.

3. The method according to claim 1 wherein,
step (c) further comprises;
automatically presenting to the user an indication that the at least one option of the plurality of options exists where the determination is made that the at least one option exists; and
determining whether to present the at least one option of the plurality of options in dependence upon a user action with respect to the indication.

4. The method according to claim 1 wherein,
the plurality of characters employ a plurality of fonts and the at least one option of a plurality of options is common to the plurality of fonts.

5. The method according to claim 1 wherein,
the available options are determined in dependence upon at least one of:
the predetermined font;
a preference of the user;
the context of the at least one character of the plurality of characters selected;
the position of the at least one character of the plurality of characters selected within a document;
the language of a document containing the at least one character of the plurality of characters selected;
the type of a document containing the at least one character of the plurality of characters selected; and
the at least one character of the plurality of characters selected.

6. The method according to claim 1 wherein;
receiving the indication relating to the selection comprises at least one of:
receiving an indication that the user has selected a predetermined portion of a document; and
receiving an indication that the user has added a predetermined portion of a document.

7. A method comprising:
a) displaying to a user at least one menu of a plurality of menus, each menu relating to an aspect of a font and comprising at least an option of a plurality of options;
b) receiving with a microprocessor an indication relating to a selection of the least one option of the plurality of options within the one menu of the plurality of menus; and
c) automatically determining with the microprocessor a plurality of fonts, each font of the plurality of fonts having a characteristic fulfilling the selection of the least one option of the plurality of options within the one menu of the plurality of menus.

8. The method according to claim 7 further comprising;
d) presenting the plurality of fonts to the user; and
e) replacing an active font within a software application in dependence upon a selection by the user of one font of the plurality of fonts.

9. The method according to claim 7 further comprising;
repeating steps (a) and (b) for a plurality of aspects of a font; and
automatically determining with the microprocessor the plurality of fonts in dependence upon the plurality of selected aspects of a font.

10. The method according to claim 7 wherein,
the plurality of fonts are those stored within a memory coupled to the microprocessor.

11. A method comprising:
a) providing a software application in execution upon a computer system comprising at least a microprocessor, the computer system connected to a network;
b) receiving a selection from a user of the software application relating to a font not currently installed for use within the software application; and
c) retrieving from a server coupled to the computer network a font file relating to the font; and
d) installing temporarily the font for use by a user of the software application.

12. The method according to claim 11 further comprising;
e) launching an evaluation window within the software application; and
f) generating content for display to the user within the evaluation using the font.

13. The method according to claim 11 further comprising:
e) generating the selection relating to a font by:
i) displaying to a user at least one menu of a plurality of menus, each menu relating to an aspect of a font and comprising at least an option of a plurality of options;
ii) receiving with the computer system an indication relating to a selection of the least one option of the plurality of options within the one menu of the plurality of menus; and
iii) automatically determining with the computer system a plurality of fonts, each font of the plurality of fonts having a characteristic fulfilling the selection of the least one option of the plurality of options within the one menu of the plurality of menus.

14. The method according to claim 13 further comprising;
repeating steps (i) and (ii) for a plurality of aspects of a font; and
automatically determining with the microprocessor the plurality of fonts in dependence upon the plurality of selected aspects of a font.

15. The method according to claim 11 further comprising;
e) receiving an indication from the user of an acceptance of the font; and
f) installing the font permanently for use by the user of the software application.

16. The method according to claim 11 further comprising;
e) receiving an indication from the user of an acceptance of the font;
f) acquiring rights to the font from a third party; and
g) installing the font permanently.
